(19) United States
(12) Patent Application Publication
(10) Pub. No.: US 2019/0001632 A1
(43) Pub. Date: Jan. 3, 2019

(54) METHOD FOR MANUFACTURING 3D POLYMER DISPERSED LIQUID CRYSTAL COMPOSITE LAYER STRUCTURE

(71) Applicant: NANOBIT TECH. CO., LTD., Taoyuan City (TW)

(72) Inventors: Shiou-Ming LIU, Taoyuan City (TW); Yu-Yang CHANG, Taoyuan City (TW); Ding-Kuo DING, Taoyuan City (TW)

(21) Appl. No.: 16/102,680

(22) Filed: Aug. 13, 2018

Related U.S. Application Data
(63) Continuation of application No. 15/052,321, filed on Feb. 24, 2016.

(30) Foreign Application Priority Data
Jan. 19, 2016 (TW) 105200776

(51) Int. Cl. B32B 27/06; B32B 7/12; B32B 1/00; B32B 27/36; B32B 27/32; B32B 27/30; B32B 27/08; B32B 7/06; B32B 27/28

(52) U.S. Cl. CPC B32B 27/06; B32B 2605/006; B32B 2509/10; B32B 2419/00; B32B 2307/732; B32B 2307/536; B32B 2307/50; B32B 2255/26; B32B 2255/10; B32B 2250/40; B32B 2250/24; B32B 2250/05; B32B 1/00; B32B 27/36; B32B 27/32; B32B 27/308; B32B 27/08; B32B 7/06; B32B 2367/00; B32B 2307/412; B32B 2307/202; B32B 2305/55; B32B 27/281; B32B 7/12

(57) ABSTRACT

The invention provides a method for manufacturing a 3D polymer dispersed liquid crystal (PDLC) composite layer structure. A 3D PDLC composite layer is first provided and has an upper transparent resin substrate, a lower transparent resin substrate, a PDLC layer, an upper protective layer and a lower protective layer. The 3D PDLC composite layer is hot-press molded to form a 3D PDLC composite layer structure with a recess portion, where internal light transmission ratio before hot pressing and after hot pressing are in a range of 0.1%-10%. The upper protective layer and the lower protective layer are removed from the resulting structure.

### CROSS-REFERENCE TO RELATED APPLICATION

This application is a continuation application of U.S. application Ser. No. 15/052,321 filed on Feb. 24, 2016. The entire disclosure is incorporated herein by reference.

### BACKGROUND OF THE INVENTION

### Field of the Invention

The present invention relates to a method for manufacturing polymer dispersed liquid crystal (PDLC), more particularly to a method for manufacturing PDLC composite layer structure with a curved surface.

### Description of the Related Art

A traditional polymer dispersed liquid crystal (PDLC) is formed by using anisotropic liquid crystal droplets distributing in polymers uniformly, typically anisotropic liquid crystal droplets with positive dielectric constant distributing in polymers uniformly that have no a specific direction in a normal state, and the light transmitted through the anisotropic liquid crystal droplets fails to match with the refractive index of the polymers so that incident light may scatter seriously due to many interfaces existing and light transmission rate is low. If a specific electric field is provided, the anisotropic liquid crystal droplets with positive dielectric constant may be arranged forward along the electric field, and the light transmitted through the anisotropic liquid crystal droplets with positive dielectric constant may match with the refractive index of the polymers so that the most incident light may transmit through forward and the light transmission rate is increased. Smart windows are formed by packaging PDLC in transparent substrates such as conductive glasses and switching the electric field on or off to control the change of transparency of the transparent substrates. Smart windows can dynamically change the tinting of glass to control the amount of light/heat that enters a building. They can also be used to create on-demand private spaces for offices. Recently, soft conductive transparent resins have been used to package PDLC instead of the conductive glasses by the advancing process and material so that the process can be simplified greatly and the application of the related products can be enhanced greatly. For example, the structure of soft conductive transparent resins packaging PDLC in combination with transparent adhesive technologies can be attached on glass of buildings, windows of cars, refrigerators or projection walls for increasing use of applications.

To meet the demand for related products, the related applications are not limited to the planar structures, other structure such as a window with the curved surface or a decorative glass with landscaping. A 3D transparent resin conductive layer structure comprising a transparent resin substrate, a curing layer and a transparent conductive layer was proposed to apple to a curved structure. In case of single axis directional curve, the curved structure can be made by soft transparent conductive substrates combining with PDLC composite layers. However, to meet the demand for two or more axis directional curve, there is a need of further designing for the related materials of PDLC composite layers.

### SUMMARY OF THE INVENTION

It is an object of the present invention to disclose a method for manufacturing a 3D polymer dispersed liquid crystal (PDLC) composite layer structure.

Accordingly, the invention provides a method for manufacturing a 3D polymer dispersed liquid crystal (PDLC) composite layer structure, the method comprising:

(a) preparing a 3D PDLC composite layer comprising an upper transparent resin substrate having an upper curing layer on a side surface thereof; a lower transparent resin substrate having a lower curing layer on a side surface thereof; an upper transparent conductive layer provided on a side surface of the upper curing layer; a lower transparent conductive layer provided on a side surface of the lower curing layer; a PDLC layer provided between the upper transparent conductive layer and the lower transparent conductive layer, an upper protective layer covering the upper transparent resin substrate and a lower protective layer covering the lower transparent resin substrate

(b) hot press molding the 3D PDLC composite layer to form a 3D PDLC composite layer structure with a recess portion;

(c) removing the upper protective layer and the lower protective layer; wherein each of the upper curing layer and the lower curing layer has a thickness in a range of 1 um-10 um and a surface hardness of 1-3H; wherein the recess portion has a curved region on a periphery thereof, and the curved region has a vertical depth at a side; wherein when the curved region is smaller than 5 mm², the curved region has a radius curvature of 1 mm; and wherein when the curved region is larger than 5 mm², the curved region has a radius curvature of 2 mm.

In an aspect of the invention, the recess portion has a curved region on the periphery, and the curved region has a vertical depth at a side. The recess portion has an internal light transmission ratio of 0.1%-10% and a change ratio of surface resist in a range of 0.1%-10%.

In an aspect of the invention, the upper and lower transparent resin substrates are made of a material of polyethylene (PE), polyimide (PI), polyethylene terephthalate (PET) or polymethylmethacrylate (PMMA). Each the upper and lower transparent resin substrates has a thickness in a range of 50 um-200 um, and preferably, a thickness of 125 um.

In an aspect of the invention, the upper curing layer and the lower curing layer are made of a UV curable type acrylic adhesive.

In an aspect of the invention, the upper and lower transparent conductive layers are formed by an organic conductive adhesive, and each of the upper and lower transparent conductive layers has a thickness in a range of 10 nm-500 nm. The organic conductive adhesive is a material selected from the group consisting of poly-3,4-ethylenedioxythiophene (PEDOT), carbon nanotube and nanosilver. The carbon nanotube or the nanosilver of the organic conductive adhesive has a diameter of 5 nm-100 nm and a length less than 20 um.

In an aspect of the invention, each the upper transparent conductive layer and the lower transparent conductive layer has a thickness in a range of 10 nm-100 nm, a surface resistivity of 100 Ω/□-300 Ω/□ and a light transmission ration of 80%-95%.

In an aspect of the invention, the PDLC layer is formed of PDLC resins having spacers. Specifically, the PDLC layer is formed of PDLC resins having spacers as a main element and mixing with a material selected from the group consisting of UV resins, thermal setting resins and silica. The 3D PDLC composite layer structure further comprises an upper protective layer provided on another side surface of the upper transparent resin substrate; and a lower protective layer provided on another side surface of the lower transparent resin substrate. The upper protective layer and the lower protective layer are made of polyethylene (PE), polyimide (PI) or polyethylene terephthalate (PET). Each the upper protective layer and the lower protective layer has a thickness in a range of 50 nm-250 nm.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 shows a side view of a PDLC composite layer structure composite layer of an embodiment according to the present invention.

FIG. 2 shows a schematic view of a PDLC composite layer which is molding by a die of an embodiment according to the present invention.

FIG. 3 shows a schematic view of a 3D PDLC composite layer structure which is formed by molding of an embodiment according to the present invention.

FIG. 4 is a side sectional view of FIG. 3.

### DETAILED DESCRIPTION OF THE INVENTION

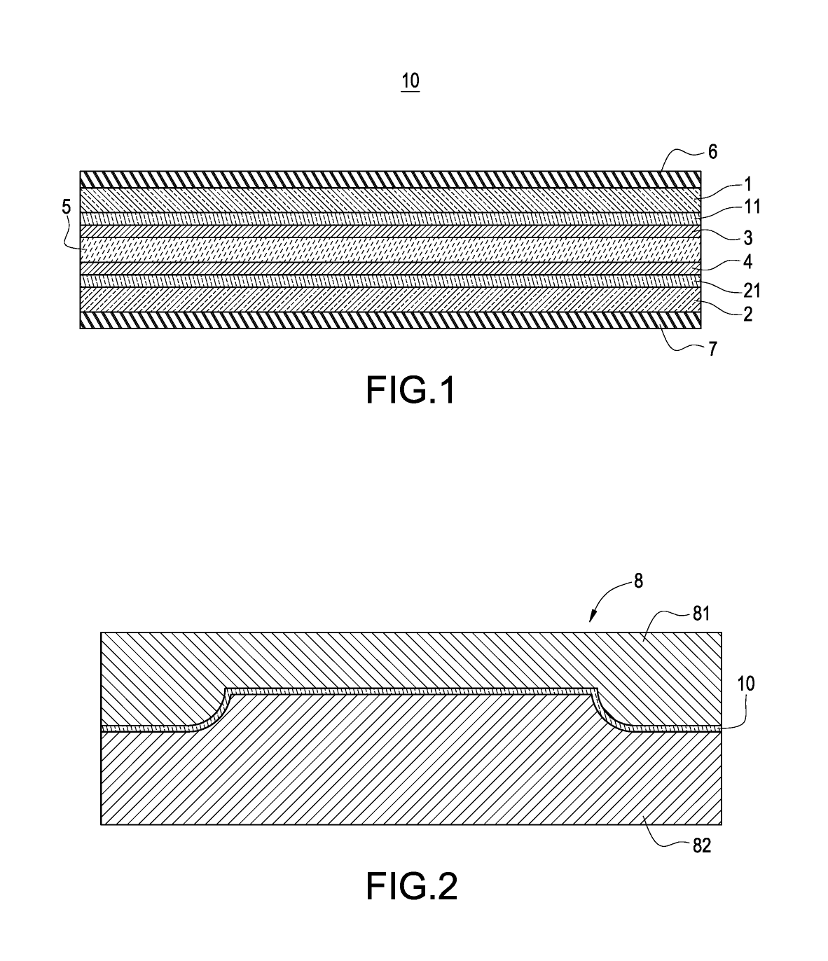

FIG. 1 shows a side view of a PDLC composite layer structure composite layer of an embodiment according to the present invention. According to FIG. 1, the 3D PDLC composite layer 10 used in the 3D PDLC composite layer structure of the invention comprises an upper transparent resin substrate 1, a lower transparent resin substrate 2, an upper transparent conductive layer 3, a lower transparent conductive layer 4, a polymer dispersed liquid crystal (PDLC) layer 5, an upper protective layer 6 and a lower protective layer 7.

The upper transparent resin substrate 1 and the lower transparent resin substrate 2 are made of a material of polyethylene (PE), polyimide (PI), polyethylene terephthalate (PET) or polymethylmethacrylate (PMMA). Each the upper transparent resin substrate 1 and the lower transparent resin substrate 2 has a thickness in a range of 50 um-200 um, and preferably, a thickness of 125 um. Also, an upper curing layer 11 is formed on a side surface of the upper transparent substrate 1 by a curing treatment of coating with a UV curable type acrylic adhesive to enhance the stiffness of the upper transparent substrate 1. A lower curing layer 21 is formed on a side surface of the lower transparent substrate 2 by a curing treatment of coating with a UV curable type acrylic adhesive to enhance the stiffness of the lower transparent substrate 2. The upper curing layer 11 has a thickness in a range of 1 um-10 um, and preferably, a thickness of 3 um. The lower curing layer 21 has a thickness in a range of 1 um-10 um, and preferably, a thickness of 3 um. The upper and lower curing layers 11, 21 have a surface hardness of 1-3H.

Each the upper and lower transparent conductive layers 3, 4 is a circuit formed by dry etching, wet etching or screen printing with an organic conductive adhesive having ductility coating on a side surface of the upper curing layer 11 and a side surface of the lower curing layer 21 respectively, and the upper transparent conductive layer 3 and the lower transparent conductive layer 4 are corresponding with each other. Each the upper and lower transparent conductive layers 3, 4 has a thickness in a range of 10 nm-500 nm, and preferably, in a range of 10 nm-100 nm. Also, the upper and lower transparent conductive layers 3, 4 have a surface resistivity of 100 Ω/□-300 Ω/□ and a light transmission ration of 80%-95%. In FIG. 1, the upper and lower transparent conductive layers 3, 4 are formed by an organic conductive adhesive that is a material selected from the group consisting of poly-3,4-ethylenedioxythiophene (PEDOT): Poly (3,4-Ethylenedioxythiophene) polystyrene sulfonate (PSS) with PEDOT as main component, carbon nanotube and nanosilver. The carbon nanotube or the nanosilver of the organic conductive adhesive has a diameter of 5 nm-100 nm and a length less than 20 um.

The PDLC layer 5 is provided between the upper transparent conductive layer 3 and the lower transparent conductive layer 4. The PDLC layer 5 is formed of PDLC resins having spacers as a main element and mixing with a material selected from the group consisting of UV resins, thermal setting resins and silica.

The upper protective layer 6 is provided on a side surface of the upper transparent resin substrate 1, and the lower protective layer 7 is provided on a side surface of the lower transparent resin substrate 2. The upper protective layer 6 and the lower protective layer 7 are used to cover the PDLC composite layer 10 for carrying out a hot press molding process. In the embodiment, the upper protective layer 6 and the lower protective layer 7 are made of polyethylene (PE), polyimide (PI) or polyethylene terephthalate (PET). The upper protective layer 6 or the lower protective layer 7 has a thickness from 50 um to 250 um. The upper protective layer 6 or the lower protective layer 7 has temperature resistance, and can be peeled off after a hot press process.

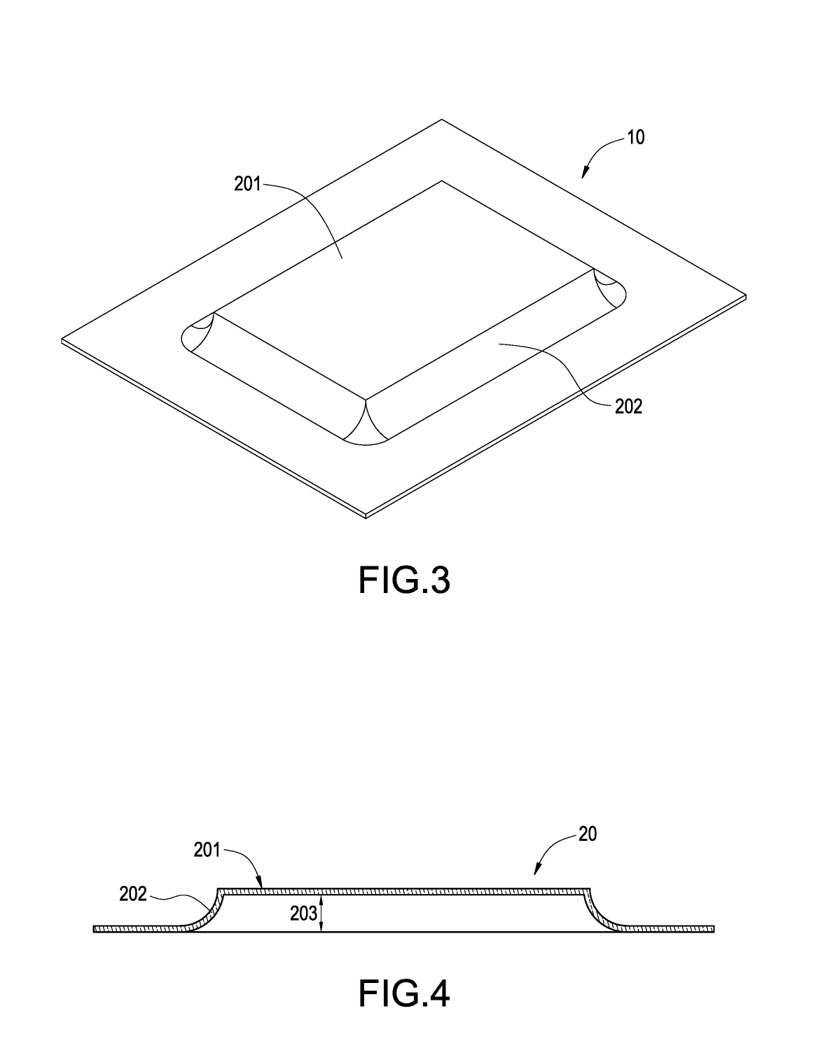

The PDLC composite layer 10 has a recess portion thereon, as shown in FIG. 3. The recess portion has an internal light transmission ratio of 0.1%-25%, and 0.1%-10% after a hot press process. The recess portion has a change ratio of surface resist in a range of 0.1%-25%, and 0.1%-10% after a hot press process.

FIG. 2 shows a schematic view of a PDLC composite layer which is molding by a die of an embodiment according to the present invention. According to FIG. 2, in the hot press of the PDLC composite layer 10 of the embodiment, a die 8 having a cavity side core 81 and a core side core 82 is firstly provided. Next, the PDLC composite layer 10 is provided between the cavity side core 81 and the core side core 82, and a hot press molding process is carried by the die 8 with a heating temperature of 250-400° C., pressure at 8-15 bar and pressing time of 10-30 seconds. Finally, a 3D PDLC composite layer structure 20 is formed after removing the die 8. In FIG. 2, preferably, a hot press molding process is carried by the die 8 with a heating temperature of 350° C., pressure at 10 bar and pressing time of 15 seconds.

FIG. 3 shows a schematic view of a 3D PDLC composite layer structure which is formed by molding of an embodiment according to the present invention. FIG. 4 is a side sectional view of FIG. 3. According to FIGS. 3 and 4, after the 3D PDLC composite layer structure 20 is formed by the hot press molding process, the upper protective layer 6 and the lower protective layer 7 are peeled off. The 3D PDLC composite layer structure 20 has a recess portion thereon after the hot press molding process, as shown in FIG. 3. The recess portion has an internal light transmission ratio of 0.1%-10% after a hot press process. The recess portion has a change ratio of surface resist in a range of 0.1%-10% after a hot press process. The recess portion 201 has a curved region 202 on the periphery, and the curved region 202 has a vertical depth 203 at a side. As the area of the curved region 202 is smaller than 5 mm², a chamfer is 1R; or as the area of the curved region 202 is larger than 5 mm², a chamfer is larger than 2R. In FIGS. 3 and 4, R indicates radius, and 1R indicates a round corner with a radius of 1 mm, and 2R indicates a round corner with a radius of 2 mm.

In an embodiment, as the 3D PDLC composite layer structure 20 has a thickness smaller than 150 um, the 3D PDLC composite layer structure 20 has a vertical depth 203 smaller than 30 mm at a side of the curved region 202. In another embodiment, as the 3D PDLC composite layer structure 20 has a thickness smaller than 250 um, the 3D PDLC composite layer structure 20 has a vertical depth 203 smaller than 50 mm at a side of the curved region 202.

The invention is not limited to these embodiments, but various variations and modifications may be made without departing from the scope of the invention.

What is claimed is:

1. A method for manufacturing a 3D polymer dispersed liquid crystal (PDLC) composite layer structure, the method comprising:
(a) preparing a 3D PDLC composite layer comprising an upper transparent resin substrate having an upper curing layer on a side surface thereof; a lower transparent resin substrate having a lower curing layer on a side surface thereof; an upper transparent conductive layer provided on a side surface of the upper curing layer; a lower transparent conductive layer provided on a side surface of the lower curing layer; a PDLC layer provided between the upper transparent conductive layer and the lower transparent conductive layer, an upper protective layer covering the upper transparent resin substrate and a lower protective layer covering the lower transparent resin substrate
(b) hot press molding the 3D PDLC composite layer to form a 3D PDLC composite layer structure with a recess portion;
(c) removing the upper protective layer and the lower protective layer;
wherein each of the upper curing layer and the lower curing layer has a thickness in a range of 1 um-10 um and a surface hardness of 1-3H;
wherein the recess portion has a curved region on a periphery thereof, and the curved region has a vertical depth at a side;
wherein when the curved region is smaller than 5 mm², the curved region has a radius curvature of 1 mm; and
wherein when the curved region is larger than 5 mm², the curved region has a radius curvature of 2 mm.

2. The method according to claim 1, wherein internal light transmission ratio before hot pressing and after hot pressing are in a range of 0.1%-10%.

3. The method according to claim 1, wherein the upper transparent resin substrate and the lower transparent resin substrate are made of a material of polyethylene (PE), polyimide (PI), polyethylene terephthalate (PET) or polymethylmethacrylate (PMMA), and each the upper transparent resin substrate and the lower transparent resin substrate has a thickness in a range of 50 um-200 um.

4. The method according to claim 1, wherein each of the upper transparent resin substrate and the lower transparent resin substrate has a thickness of 125 um.

5. The method according to claim 1, wherein the upper curing layer and the lower curing layer are made of a UV curable type acrylic adhesive.

6. The method according to claim 1, wherein each the upper curing layer and the lower curing layer has a thickness of 3 um.

7. The method according to claim 1, further comprising: forming the upper and lower transparent conductive layers by an organic conductive adhesive, and wherein each of the upper and lower transparent conductive layers has a thickness in a range of 10 nm-500 nm.

8. The method according to claim 7, wherein the organic conductive adhesive is a material selected from the group consisting of poly-3,4-ethylenedioxythiophene (PEDOT), carbon nanotube and nanosilver.

9. The method according to claim 8, wherein the carbon nanotube or the nanosilver of the organic conductive adhesive has a diameter of 5 nm-100 nm and a length less than 20 um.

10. The method according to claim 9, wherein each the upper transparent conductive layer and the lower transparent conductive layers has a thickness in a range of 10 nm-100 nm, a surface resistivity of 100 Ω/□-300 Ω/□ and a light transmission ration of 80%-95%.

11. The method according to claim 1, wherein the PDLC layer is formed of PDLC resins having spacers.

12. The method according to claim 11, further comprising: forming the PDLC layer by using the PDLC resins as main element and mixing the PDLC resins with a material selected from the group consisting of UV resins, thermal setting resins and silica.

13. The method according to claim 12, further comprising: arranging an upper protective layer on another side surface of the upper transparent resin substrate; and a lower protective layer on another side surface of the lower transparent resin substrate.

14. The method according to claim 13, wherein the upper protective layer and the lower protective layer are made of polyethylene (PE), polyimide (PI) or polyethylene terephthalate (PET).

15. The method according to claim 14, wherein each the upper protective layer and the lower protective layer has a thickness in a range of 50 nm-250 nm.
